(19) United States
(12) Patent Application Publication
(10) Pub. No.: US 2020/0101601 A1
(43) Pub. Date: Apr. 2, 2020

(54) CONTROL SYSTEM AND METHOD FOR A ROBOT

(71) Applicant: Siemens Aktiengesellschaft, Muenchen (DE)

(72) Inventors: Yue ZHUO, Beijing (CN); George LO, Langhorne, PA (US); Zi Jian WANG, Beijing (CN)

(73) Assignee: Siemens Aktiengesellschaft, Muenchen (DE)

(21) Appl. No.: 16/583,465

(22) Filed: Sep. 26, 2019

(30) Foreign Application Priority Data
Sep. 28, 2018 (EP) 18197713.3

(51) Int. Cl. B25J 9/16; G05B 19/05

(52) U.S. Cl. CPC B25J 9/1605; B25J 9/161; G05B 2219/13004; G05B 19/056; B25J 9/1671

(57) ABSTRACT

A control system is for a robot. In an embodiment, the control system includes a program executor to translate a motion command for a robot to a format identifiable by a robot control kernel; a robot control kernel to generate robot motion data based on the translated motion command; and a robot Digital Twin to simulate the motion of the robot based on the generated robot motion data and physical conditions of the robot during robot simulation.

### PRIORITY STATEMENT

The present application hereby claims priority under 35 U.S.C. § 119 to European patent application number EP 18197713.3 filed Sep. 28, 2018, the entire contents of which are hereby incorporated herein by reference.

### FIELD

Embodiments of the application generally relate to robot field, especially industrial robots, and more particularly, to a control system for a robot and a method for simulating motion of a robot in the control system.

### BACKGROUND

In an industrial robot field, a robot simulation system is used to create application for a physical robot. The robot movement for the application may be verified before actually moving the physical robot. Robot simulation is used to simulate the movement of the physical robot so as to carry out the verification. The robot simulation is the key technology for an industrial robot and automation.

Current robot simulation may be classified into two categories. The first category is a virtual robot in a simulation environment. In this case, a virtual robot with a 3D model and motion control algorithm is constructed in a simulation environment, which is capable of emulating the motion of a physical robot in a real work envelope. However, the simulation environment is different from the physical robot control environment. Thus, the simulated robot movement may not be repeated accurately in the physical environment. This will raise certain risks, including collision between a robot and an object, and thus declining in trajectory accuracy. Additionally, for the first category, the simulation is only about the robot control algorithm part, and the virtual robot will move according to the theoretical output of the algorithm without considering the physical conditions of the robot (e.g., the mass of the robot arm, the motor friction of the joints).

The second category is display of robot movement based on physical robot movement data. In this case, a robot 3D model is constructed in a simulation environment, and the movement of a physical robot is displayed based on the physical robot movement data. In the second category, there is no simulation procedure, only the robot 3D model is driven by the recorded or real-time movement data of a physical robot. In this case, an additional system (including computing and display components) is required to run the control system or the robot 3D model, which will increase the cost of the whole robot system.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

According to an embodiment of the subject matter described herein, a control system for a robot, comprises: a program executor to translate a motion command for the robot so as to have a format that is identifiable by a robot control kernel; a robot control kernel to generate robot motion data based on the translated motion command; and a robot Digital Twin to simulate the motion of the robot based on the generated robot motion data and physical conditions of the robot during robot simulation.

According to an embodiment of the subject matter, a method for simulating motion of a robot in a control system, comprises: translating a motion command for the robot so as to have a format that is identifiable by a robot control kernel of the control system; generating robot motion data based on the translated motion command by the robot control kernel; and simulating the motion of the robot based on the generated robot motion data and physical conditions of the robot during robot simulation.

According to an embodiment of the subject matter, an apparatus for simulating motion of a robot in a control system, comprises: a translating means for translating a motion command for the robot from a robot operator so as to have a format that is identifiable by a generating means; a generating means for generating robot motion data based on the translated motion command; and a simulating means for simulating the motion of the robot based on the generated robot motion data and physical conditions of the robot during robot simulation.

According to an embodiment of the subject matter, a computer system for simulating motion of a robot in a control system, comprises: one or more processors; and a memory coupled to the one or more processors, for storing computer-executable instructions that, when executed, cause the one or more processors to perform the method for simulating motion of a robot in a control system as above.

According to an embodiment of the subject matter, a non-transitory computer-readable medium having computer-executable instructions to cause a computer system to perform the method for simulating motion of a robot in a control system as above.

### BRIEF DESCRIPTION OF THE DRAWINGS

Various aspects, features and advantages of the subject matter will be more apparent from the detailed description set forth below when taken in conjunction with the drawings, in which use of the same reference number in different figures indicates similar or identical items.

FIG. 1 illustrates a block diagram of a control system for a robot according to an embodiment of the subject matter;

FIG. 2 illustrates an example of a human machine interface according to an embodiment of the subject matter;

FIG. 3 illustrates a method flowchart for simulating motion of a robot in the control system according to an embodiment of the subject matter;

FIG. 4 illustrates a data flow for a simulation mode in a control system according to an embodiment of the subject matter;

FIG. 5 illustrates a data flow for a real mode in a control system according to an embodiment of the subject matter;

FIG. 6 illustrates an example of a control system having a dual-core according to an embodiment of the subject matter;

FIG.7 illustrates a block diagram of an apparatus for simulating motion of a robot in a control system according to an embodiment of the subject matter; and

FIG. 8 illustrates a block diagram of a computer system for simulating motion of a robot in a control system according to an embodiment of the subject matter.

### LISTING OF REFERENCE NUMERALS

10 control system
20 HMI device
30 drive
40 motor
50 display device
110 program executor
120 robot control kernel
130 robot Digital Twin
140 parser
150 HMI
160 drive interface
1 key switch
2 emergency button
3 start/stop button
4 jogging button
5 step/continuous button
6 robot program window
7 save and check button
310 translate a motion command for a robot so as to have a format that is identifiable by a robot control kernel
320 generate robot motion data based on the translated motion command
330 configure operation mode according to an operation mode instruction
340 communicate the generated robot motion data to the robot Digital Twin
350 simulate the motion of the robot based on the generated robot motion data and physical conditions of the robot
360 communicate the generated robot motion data to the drive for a motor on the robot body
370 control the motors on the robot body to move according to the robot motion data from the robot control kernel
380 send real robot motion data to the robot Digital Twin
390 perform the simulation based on the real robot motion data
700 apparatus
710 translating device(s)
720 generating device(s)
730 simulating device(s)
740 configuring device(s)
750 communicating device(s)
760 parsing device(s)
800 computer system
810 one and more processors
820 memory

### DETAILED DESCRIPTION OF THE EXAMPLE EMBODIMENTS

The subject matter described herein will now be discussed with reference to example embodiments. It should be understood these embodiments are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to”. The term “based on” is to be read as “based at least in part on”. The terms “one embodiment” and “an embodiment” are to be read as “at least one implementation”. The term “another embodiment” is to be read as “at least one other embodiment”. The term “a” or “an” is to be read as “at least one”. The terms “first”, “second”, and the like may refer to different or same objects. Other definitions, explicit and implicit, may be included below. A definition of a term is consistent throughout the description unless the context clearly indicates otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

According to an embodiment of the subject matter described herein, a control system for a robot, comprises: a program executor to translate a motion command for the robot so as to have a format that is identifiable by a robot control kernel; a robot control kernel to generate robot motion data based on the translated motion command; and a robot Digital Twin to simulate the motion of the robot based on the generated robot motion data and physical conditions of the robot during robot simulation.

In an example of the above embodiment, the robot control kernel may be further configured to: configure its operation mode according to an operation mode instruction for the robot, wherein the operation mode includes one of a simulation mode and a real mode, and communicate the generated robot motion data to the robot Digital Twin when the operation mode is the simulation mode or to a drive for a motor on the robot body when the operation mode is the real mode.

In an example of the above embodiment, the control system may include a command parser to parse an operation mode command for the robot from the robot operator so as to identify the operation mode instruction.

In an example of the above embodiment, the robot Digital Twin may be further configured to: receive real robot motion data from the drive when the operation mode is the real mode, and simulate the motion of the robot based on the received real robot motion data.

In an example of the above embodiment, the physical conditions of the robot may comprise: physical parameters of the robot body and payload of the robot.

In an example of the above embodiment, the physical parameters of the robot body comprise at least one of: robot arm's mass, robot arm's length, motor fiction of each motor, and gravity of each joint, maximum rotation speed of each motor, rotation inertia of each motor, a torque of each motor and a current of each motor.

In an example of the above embodiment, the control system may include a human machine interface to input the operation mode command and the motion command; and/or a drive interface to exchange data between the robot control kernel and the drive.

In an example of the above embodiment, the robot Digital Twin may be further configured to send the simulated motion data of the robot back to the robot control kernel when the operation mode is the simulation mode, and the robot control kernel may be further configured to adjust the generated robot motion data based on the simulated motion data.

In an example of the above embodiment, the robot control kernel may be further configured to receive real robot motion data from the drive when the operation mode is the real mode, and adjust the generated robot motion data based on the real robot motion data.

In an example of the above embodiment, the robot motion data may comprise at least one of: position of each joint of the robot, velocity of each joint of the robot, and acceleration of each joint of the robot.

In an example of the above embodiment, the control system may be a dual-core system including an operation system (OS) core and a programmable logic controller (PLC) core, and wherein the robot Digital Twin is deployed on the OS core, and the program executor and the robot control kernel are deployed on the PLC core.

According to an embodiment of the subject matter, a method for simulating motion of a robot in a control system, comprises: translating a motion command for the robot so as to have a format that is identifiable by a robot control kernel of the control system; generating robot motion data based on the translated motion command by the robot control kernel; and simulating the motion of the robot based on the generated robot motion data and physical conditions of the robot during robot simulation.

In an example of the above embodiment, the method further comprises: configuring its operation mode according to an operation mode instruction for the robot, wherein the operation mode includes one of a simulation mode and a real mode, and communicating the generated robot motion data to the robot Digital Twin when the operation mode is the simulation mode or to a drive for a motor on the robot body when the operation mode is the real mode.

In an example of the above embodiment, the method further comprises: parsing an operation mode command for the robot from the robot operator so as to identify the operation mode instruction.

In an example of the above embodiment, the method further comprises: receiving real robot motion data from the drive when the operation mode is the real mode, and simulating the motion of the robot based on the received real robot motion data.

In an example of the above embodiment, the method further comprises: adjusting the generated robot motion data based on the simulated motion data.

In an example of the above embodiment, the method further comprises: receiving real robot motion data from the drive when the operation mode is the real mode, and adjusting the generated robot motion data based on the real robot motion data.

According to an embodiment of the subject matter, an apparatus for simulating motion of a robot in a control system, comprises: a translating means for translating a motion command for the robot from a robot operator so as to have a format that is identifiable by a generating means; a generating means for generating robot motion data based on the translated motion command; and a simulating means for simulating the motion of the robot based on the generated robot motion data and physical conditions of the robot during robot simulation.

According to an embodiment of the subject matter, a computer system for simulating motion of a robot in a control system, comprises: one or more processors; and a memory coupled to the one or more processors, for storing computer-executable instructions that, when executed, cause the one or more processors to perform the method for simulating motion of a robot in a control system as above.

According to an embodiment of the subject matter, a non-transitory computer-readable medium having computer-executable instructions to cause a computer system to perform the method for simulating motion of a robot in a control system as above.

With the above control system, simulation method and apparatus, the motion of the robot may be simulated based on both the generated robot motion data by the robot control kernel and physical conditions of the robot, and thus the simulation result may conform to the actual physical environment of the robot.

With the above control system, simulation method and apparatus, by configuring the operation mode of the robot control kernel according to an operation mode instruction for the robot, and communicating the generated robot motion data to the robot Digital Twin or a drive for a motor on the robot according to the configuration of the operation mode, both the simulation and the real movement of the robot may be realized in one control system.

With the above control system, simulation method and apparatus, by providing a parser in the control system, the robot operator may input the operation mode command in a simpler way.

With the above control system, simulation method and apparatus, by adjusting the generated robot motion data based on the simulated motion data, the robot motion data from the robot control kernel may be more accurate.

With the above control system, simulation method and apparatus, by adjusting the generated robot motion data based on the real robot motion data, the robot motion data from the robot control kernel may be more accurate.

With the above control system, simulation method and apparatus, by providing the robot Digital Twin to be deployed on the Windows core, and the program executor and the robot control kernel to be deployed on the PLC core, the efficiency of the control system may be improved significantly.

In the current robot simulation approach, the robot simulation is based on a 3D model and motion control algorithm constructed in a simulation environment, which cannot conform to the actual physical environment of the robot. In order to solve the above problem, a new simulation approach is provided in the application. In the provided simulation approach, the motion of the robot may be simulated based on both the generated robot motion data by the robot control kernel and physical conditions of the robot, and thus the simulation result may conform to the actual physical environment of the robot.

In the application, term “Digital Twin” refers to a simulation process integrating multidisciplinary, multiphysics, multi-scale, multi-probability, which makes full use of the physical model, sensor update, operating history and other data, and completes the mapping in the virtual space to reflect the corresponding physical equipment life cycle process.

In the application, term “robot motion data” refers to the motion data of a robot generated by the robot control kernel based on the motion command, and term “real robot motion data” refers to real motion data of a robot during moving according to the generated robot motion data from the robot control kernel.

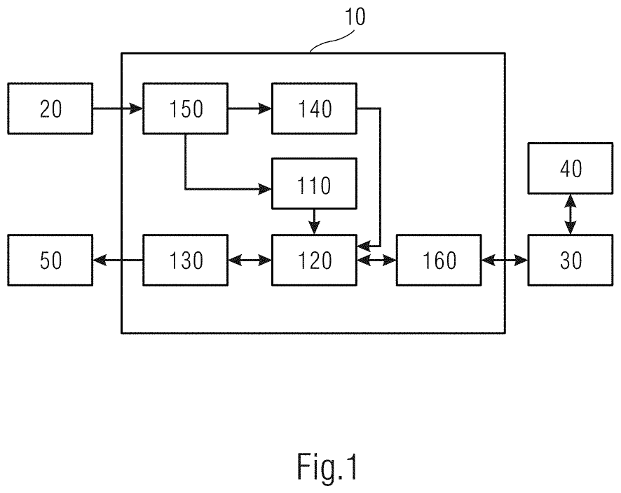

FIG. 1 illustrates a block diagram of a control system 10 for a robot according to an embodiment of the subject matter. As shown in FIG. 1, the control system 10 includes a program executor 110, a robot control kernel 120 and a robot Digital Twin 130.

The program executor 110 is configured to translate a motion command for a robot from a robot operator so as to have a format that is identifiable by the robot control kernel 120. In the embodiments, the motion command may be a command for instructing a robot to move in a specified motion manner. The motion command for a robot may include a moving command, a grabbing command, a releasing command, a walking command, a running command, a rotating command, a jumping command etc. In general, the motion command may have a format that may be identified by the program executor 110 (such as a text format, a program language format etc.) and unidentified by the robot control kernel 120, and inputted to the program executor 110 from or by a robot operator (e.g., via a human machine interface (HMI) 150). After receiving the motion command, the program executor 110 may translate the format of the motion command so as to have a format that is identifiable by the robot control kernel 120, that is, translate the motion command into a command and a parameter value of the command that are identifiable by the robot control kernel 120. For example, after receiving the motion command, the program executor 110 may load the program command or the program corresponding to the command having a text format, and translate the command into a format that is identifiable by the robot control kernel 120. Here, the program executor 110 is similar to a compiler for a program.

The robot control kernel 120 is configured to generate robot motion data based on the translated motion command. In the embodiments, the motion data may include position of each joint of the robot. In other embodiments, the motion data may further include one of the following: velocity of each joint of the robot, and acceleration of each joint of the robot.

In other embodiments, the robot control kernel 120 is also configured to configure its operation mode according to an operation mode instruction. The operation modes may include a simulation mode and a real mode. The simulation mode is a mode in which a motion simulation for a physical robot is performed, and the real mode is a mode in which the physical robot is really moved.

After configuration of the operation mode, the robot control kernel 120 may communicate the generated robot motion data to the robot Digital Twin 130 when the configured operation mode is the simulation mode, or communicate the generate robot motion data to a drive (or drives) 30 for a motor (or motors) 40 on the robot body when the configured operation mode is the real mode. The operation mode instruction may be also input from a robot operator (e.g., via a human machine interface (HMI) 150). Here, the drive 30 may be all kinds of drivers that can drive/control motors on the robot body. After receiving the robot motion data from the robot control kernel 120, the drive 30 controls the motors on the robot body to move according to the robot motion data from the robot control kernel 120, and receives the real motion data of the robot from the motors 40.

The robot Digital Twin 130 is the 3D modeling for robot simulation, and is configured to simulate the motion of the robot based on the generated robot motion data and physical conditions of the robot when the operation mode for the robot control kernel 120 is the simulation mode. The physical conditions of the robot may include: physical parameters of the robot body and payload of the robot. In an example, the physical parameters of the robot body may include at least one of: robot arm's mass, robot arm's length, motor fiction of each motor, and gravity of each joint, maximum rotation speed of each motor, rotation inertia of each motor, a torque of each motor and a current of each motor. The payload of the robot is the payload handled by the robot, such as the payload installed on the robot flange, an object holed by a robot arm etc. The robot Digital Twin 130 may receive the robot motion data from the robot control kernel 120 and physical conditions of the robot from the encoder of the motors, simulate the motion of the robot with the 3D modeling using the received robot motion data and physical conditions of the robot, and send the simulation result of the robot to a display device 50 external to the control system 10, and the display device 50 then displays the simulation result.

In another embodiment, the robot Digital Twin 130 may be further configured to communicate with the drive 30 for a motor 40 on the robot body when the operation mode is the real mode so as to receive real robot motion data from the drive 30, and simulate the motion of the robot based on the received real motion data. As much, the robot Digital Twin 130 may send the simulation result of the robot to a display device 50 external to the control system 10, and the display device 50 then displays the simulation result.

Further, in another embodiment, the control system 10 may include a command parser 140. The command parser 140 is configured to parse an operation mode command from the robot operator so as to identify the operation mode instruction. In an example, the robot operator inputs an operation mode command to the command parser 140 via an operation mode selection button provided on the HMI device 20. Here, the operation mode command may include a simulation mode command or a real mode command. After receiving the robot operation command, the command parser 140 parsers the inputted operation mode command to identify an operation mode instruction corresponding to the robot operation command. Then, the command parser 140 sends the identified operation mode instruction to the robot control kernel 120. The robot control kernel 120 configures its operation mode according to the identified operation mode instruction.

In other embodiments, the control system 10 may further include a human machine interface (HMI) 150 for input the operation mode command for robot and the motion command for robot. In an example, the robot operator may input operation commands and the motion command to the control system 10 via the HMI 150 by using a HMI device 20. In this case, the HMI 150 is provided between the HMI device 20 and the command parser 140/the program executor 110. In other embodiments, the HMI 150 may also be provided on a device external to the control system, such as a computer, a tablet, and a mobile terminal etc.

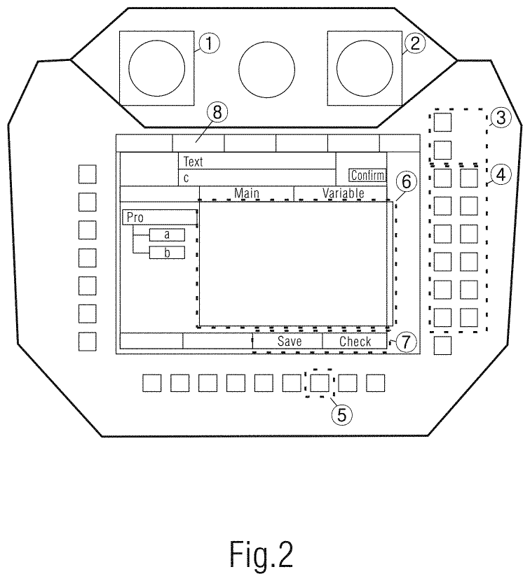

FIG. 2 illustrates an example of a human machine interface according to an embodiment of the subject matter. As shown in FIG. 2, a robot operator can input a robot motion command (i.e., a robot program) via a robot programming window 6. After saving and language checking of the robot motion command (through pressing a saving and language checking button 7), the robot motion command can be loaded to the program executor 110 for translation.

Further, the robot operator can input an operation mode command to the command parser 140 via a button for choosing a simulation mode or a real mode. Here, the button may be a virtual button or a physical button. The command parser 140 parses the operation mode command to obtain an operation mode instruction. Further, the robot operator can input a program START/END command via a Start/Stop button 3 to the command parser 140. After parsing the program START/END command, the command parser 140 may send a program start/end instruction to the program executor 110 so as to start/end the execution of the robot program, i.e., the translation of the inputted program command.

In other embodiments, the control system 10 may further include a drive interface 160 for exchanging data between the robot control kernel 120 and the drive 40 for motors on the robot.

In other embodiments, the robot Digital Twin 130 may be further configured to send the simulated motion data of the robot back to the robot control kernel 120 when the operation mode is the simulation mode, and the robot control kernel 120 then adjusts the robot motion data based on the simulated motion data. For example, the robot control kernel 120 may adjust the position set point calculated based on the motor position feedback from the robot Digital Twin, thus the motor position can follow the position set point calculated by the robot control kernel in time. By adjusting the robot data in the robot control kernel 120, the influence caused by the physical conditions of the robot (e.g., the heavy payload on the robot flange) may be compensated.

In other embodiments, the robot control kernel 120 may be further configured to: receive real robot motion data from the drive 40 for motors on the robot body when the operation mode is the real mode, and adjust the robot motion data based on the received real robot motion data.

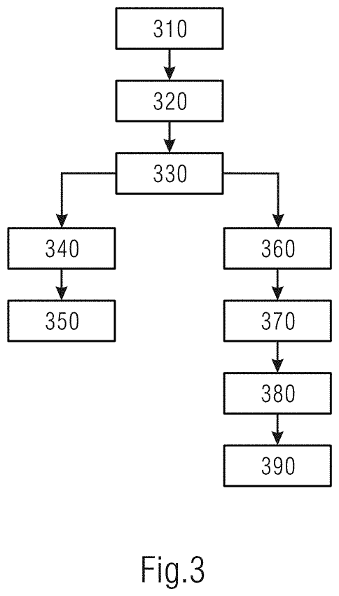

FIG. 3 illustrates a flowchart for simulating in the control system according to an embodiment of the subject matter. As shown in FIG.3, in block 310, the program executor 110 translates a motion command for a robot so as to have a format that is identifiable by a robot control kernel 120. In the embodiments, the motion command may be a command for instructing a robot to move in a specified motion manner. The motion command for a robot may include a moving command, a grabbing command, a releasing command, a walking command, a running command, a rotating command, a jumping command etc. In general, the motion command may have a format that may be identified by the program executor 110 (such as a text format, a program language format etc.) and unidentified by the robot control kernel 120, and inputted to the program executor 110 from a robot operator (e.g., via a human machine interface (HMI) 150). After receiving the motion command, the program executor 110 may translate the format of the motion command so as to have a format that is identifiable by the robot control kernel 120, that is, translate the motion command into a command and a parameter value of the command that are identifiable by the robot control kernel 120. Here, the program executor 110 is similar to a compiler.

In block 320, the program executor 110 sends the translated motion data to the robot control kernel 120, and the robot control kernel 120 generates robot motion data based on the received translated motion command. Next, in block 330, the robot control kernel 120 configures its operation mode according to an operation mode instruction, wherein the operation mode is a simulation mode or a real mode. Here, the operation mode instruction may be inputted by the robot operator.

When the robot control kernel 120 is configured to operate at a simulation mode, in block 340, the robot control kernel 120 communicates the generated robot motion data to the robot Digital Twin 130. Next, in block 350, the robot Digital Twin 130 simulates the motion of the robot based on the generated robot motion data and physical conditions of the robot. Here, the physical conditions of the robot may be received from the encoder of the motors in advance or in time.

When the robot control kernel 120 is configured to operate at a real mode, in block 360, the robot control kernel 120 communicates the generated robot motion data to the drive 30 for a motor 40 on the robot body. Next, in block 370, the drive 30 controls the motors on the robot body to move according to the robot motion data from the robot control kernel 120, and the drive 30 also receives real motion data of the robot from the motor 40.

After receiving the real motion data of the robot from the motors 40, in block 380, the drive 30 sends the real motion data of the robot to the robot Digital Twin 130. Then, in block 390, the robot Digital Twin 130 performs the simulation based on the real motion data of the robot. In other embodiments, the robot Digital Twin 130 may send the simulation result to a display unit external to the control system 10 for displaying.

In another embodiment, the robot operator inputs a robot operation command via the HMI device 20 and the HMI 150, and the method further include: parsing the robot operation command from a robot operator so as to identify the operation mode instruction for the robot control kernel 120. In this case, the robot control kernel 120 configures its operation mode according to the identified operation mode instruction.

It is noted that the embodiment of FIG. 3 is only an implementation of the application. In other embodiments, some steps of flowchart in FIG. 3 may be omitted or some new steps may be added into the flowchart in FIG. 3. For example, in a method for simulating in the control system according to an embodiment of the subject matter, there may be blocks 310, 320, 340 and 350.

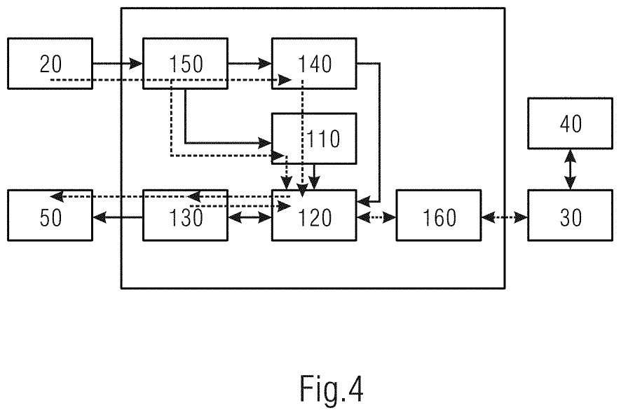

FIG. 4 illustrates a data flow for a simulation mode in a control system according to an embodiment of the subject matter. As shown in FIG. 4, a robot operator inputs a simulation operation mode command and a motion command via a HMI 150 using a HMI device 20. After receiving the simulation operation mode command, the command parser 140 identifies a simulation mode instruction for the robot control kernel 120, and then sends the simulation mode instruction to the robot control kernel 120. The robot control kernel 120 configures its operation mode as a simulation mode. After receiving the motion command with a format that is unidentifiable by the robot control kernel 120, the program executor 110 translates the format of the motion command so as to have a format that is identifiable by the robot control kernel 120. The robot control kernel 120 generates robot motion data based on the translated motion command. Further, the robot control kernel 120 sends the generated robot motion data to the robot Digital Twin 130. The robot Digital Twin 130 performs the simulation based on the robot motion data and physical conditions of the robot, and then sends the simulation result to the display device 50 for displaying. Further, the robot Digital Twin 130 may sends the simulation motion data back to the robot control kernel 120, and the robot control kernel 120 uses the simulation motion data to adjust its original generated robot motion data.

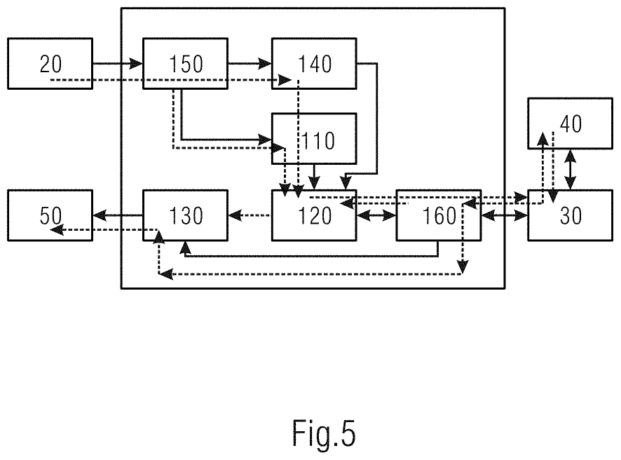

FIG. 5 illustrates a data flow for a real mode in a control system according to an embodiment of the subject matter. As shown in FIG. 5, a robot operator inputs a real operation mode command and a motion command via a HMI 150 using a HMI device 20. After receiving the real operation mode command, the command parser 140 identifies a real mode instruction for the robot control kernel 120, and then sends the real mode instruction to the robot control kernel 120. The robot control kernel 120 configures its operation mode as a real mode. After receiving the motion command with a format that is unidentifiable by the robot control kernel 120, the program executor 110 translates the format of the motion command so as to have a format that is identifiable by the robot control kernel 120. The robot control kernel 120 generates robot motion data based on the translated motion command. Further, the robot control kernel 120 sends the generated robot motion data to the drive 30 for the motor 40 on the robot body via a drive interface 160. After receiving the robot motion data, the drive 30 controls the motor 40 on the robot body to move according to the robot motion data from the robot control kernel 120, and receives the real motion data of the robot from the motors 40. The drive 30 may send the real motion data back to the robot control kernel 120, and the robot control kernel 120 uses the real motion data to adjust its original generated robot motion data. The drive 30 may also send the real motion data back to the robot Digital Twin 130. The robot Digital Twin 130 performs the simulation based on the real motion data of the robot, and then sends the simulation result to the display device 50 for displaying.

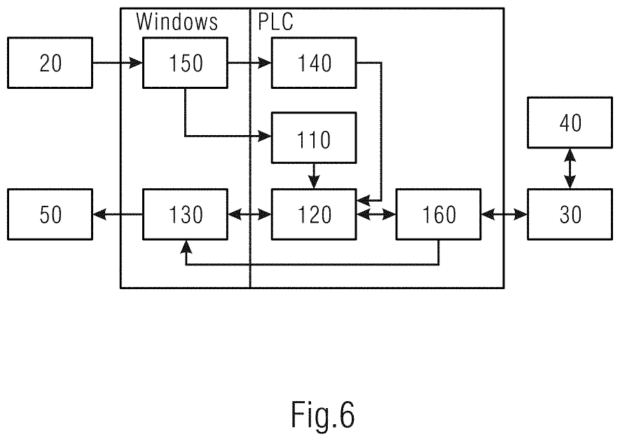

Further, in other embodiments, the control system 10 may be a dual-core system, wherein one core is an operation system (OS) core and the other core is a programmable logic controller (PLC) core. The OS core may include a Windows core or a Linux core. FIG. 6 illustrates an example of a control system having a dual-core according to an embodiment of the subject matter. As shown in FIG.6, the HMI 150 and the robot Digital Twin 130 are deployed on the Windows core, and the command parser 140, the program executor 110, the robot control kernel 120 and the drive interface 160 are deployed on the PLC core.

It should be appreciated that although various modules and functions are described with reference to FIGS. 1-6, not all of the functions and/or modules are necessary in a specific implementation and some functions may be implemented in one module and may also be implemented in multiple modules.

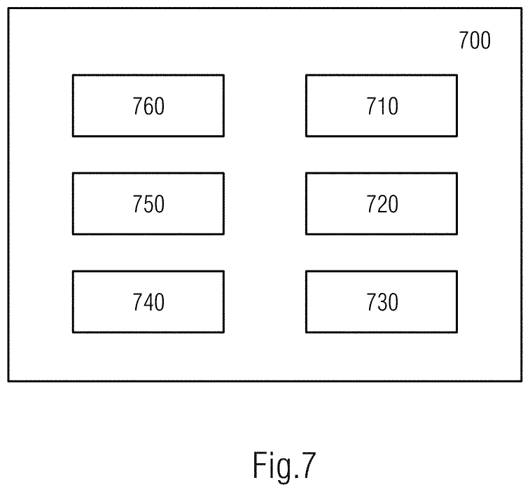

FIG. 7 illustrates an apparatus 700 for simulating a motion of a robot according to an embodiment of the subject matter. The apparatus 700 may include a translating device(s) 710, a generating device(s) 720, and a simulating device(s) 730.

The translating device(s) 710 is configured to translate a motion command for the robot for a robot so as to have a format that is identifiable by a robot control kernel 120 of the control system 10. The generating device(s) 720 is configured to generate robot motion data based on the translated motion command. The simulating device(s) 730 is configured to simulate the motion of the robot based on the generated robot motion data and physical conditions of the robot during robot simulation.

Further, the apparatus 700 may also include a configuring device(s) 740 and a communicating device(s) 750. The configuring device(s) 740 is adapted to configure an operation mode for a robot according to an operation mode instruction, wherein the operation mode may be one of a simulation mode and a real mode. The communicating device(s) 750 is configured to communicate the generated robot motion data to a simulating means when the configured operation mode is the simulation mode or to a drive for a motor on the robot body when the configured operation mode is the real mode.

Further, the simulating device(s) 730 may be also configured to receive real robot motion data from the drive for the motor on the robot body when the configured operation mode is the real mode, and simulate the motion of the robot based on the received real robot motion data.

Further, the apparatus 700 may further include a parsing device(s) 760 for parsing an operation mode command from a robot operator so as to identify the operation mode instruction for the robot control kernel. In this case, the configuring device(s) 740 is for configuring an operation mode of the robot control kernel according to the identified operation mode instruction.

It should be appreciated that the translating device(s) 710, the generating device(s) 720, the simulating device(s) 730, the configuring device(s) 740, the communicating device(s) 750 and the parsing device(s) 760 may be configured to perform the operations or functions described above with reference to FIGS. 1-6.

It should be appreciated that modules and corresponding functions described with reference to FIGS. 1-6 are for sake of illustration rather than limitation, a specific function may be implemented in different modules or in a single module.

The respective modules as illustrated in FIGS. 1-6 may be implemented in various forms of hardware, software or combinations thereof. In an embodiment, the modules may be implemented separately or as a whole by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. In another embodiment, the modules may be implemented by one or more software modules, which may be executed by a general central processing unit (CPU), a graphic processing unit (GPU), a Digital Signal Processor (DSP), etc.

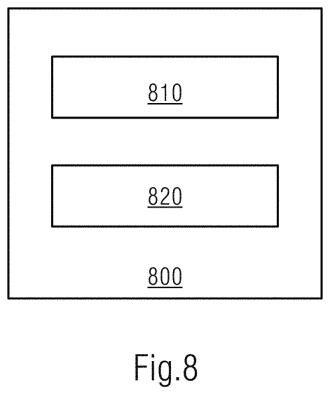

FIG. 8 illustrates a block diagram of a computer system 800 for simulating a motion of a robot according to an embodiment of the subject matter. According to one embodiment, the computer system 800 may include one or more processors 810 that execute one or more computer readable instructions stored or encoded in computer readable storage medium such as memory 820.

In an embodiment, the computer-executable instructions stored in the memory 820, when executed, may cause the one or more processors to: translate a motion command for a robot so as to have a format that is identifiable by a robot control kernel; generate robot motion data by the robot control kernel based on the translated motion command; and simulate the motion of the robot based on the generated robot motion data and physical conditions of the robot during robot simulation.

According to an embodiment, a program product such as a machine-readable medium is provided. The machine-readable medium may have instructions thereon which, when executed by a machine, cause the machine to perform the operations or functions as described above with reference to FIGS. 1 to 6 in various embodiments of the subject matter.

It should be noted that the above-mentioned solutions illustrate rather than limit the subject matter and that those skilled in the art would be able to design alternative solutions without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the system claims enumerating several units, several of these units can be embodied by one and the same item of software and/or hardware. The usage of the words first, second and third, et cetera, does not indicate any ordering. These words are to be interpreted as names.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A control system for a robot, comprising:
a program executor to translate a motion command for the robot to a format identifiable by a robot control kernel;
a robot control kernel to generate robot motion data based on the motion command translated; and
a robot Digital Twin to simulate motion of the robot based on the robot motion data generated and physical conditions of the robot during robot simulation.

2. The control system of claim 1, wherein the robot control kernel is further configured to:
configure its operation mode according to an operation mode instruction for the robot, wherein the operation mode includes one of a simulation mode and a real mode; and
communicate the robot motion data generated to the robot Digital Twin when the operation mode configured is the simulation mode or to communicate the robot motion data generated to a drive for a motor on the robot body when the operation mode configured is the real mode.

3. The control system of claim 2, further comprising:
a command parser to parse an operation mode command for the robot to identify the operation mode instruction.

4. The control system of claim 2, wherein the robot Digital Twin is further configured to:
receive real robot motion data from the drive when the operation mode is the real mode, and simulate the motion of the robot based on the real robot motion data received.

5. The control system of claim 1, wherein the physical conditions of the robot comprise: physical parameters of the robot body and payload of the robot.

6. The control system of claim 5, wherein the physical parameters of the robot body comprise at least one of: robot arm's mass, robot arm's length, motor fiction of each motor, and gravity of each joint, maximum rotation speed of each motor, rotation inertia of each motor, a torque of each motor and a current of each motor.

7. The control system of claim 1, further comprising at least one of:
a human machine interface to input at least one of the operation mode command and the motion command; and
a drive interface to exchange data between the robot control kernel and the drive.

8. The control system of claim 2, wherein the robot Digital Twin is further configured to send the motion data of the robot, once simulated, back to the robot control kernel when the operation mode is the simulation mode, and wherein the robot control kernel is further configured to adjust the robot motion data generated based on the motion data simulated.

9. The control system of claim 2, wherein the robot control kernel is further configured to:
receive real robot motion data from the drive when the operation mode is the real mode, and
adjust the robot motion data generated based on the real robot motion data received.

10. The control system of claim 1, wherein the robot motion data comprises at least one of: position of each joint of the robot, velocity of each joint of the robot, and acceleration of each joint of the robot.

11. The control system of claim 1, wherein the control system is a dual-core system including an operation system core and a programmable logic controller core, and wherein the robot Digital Twin is deployed on the OS core, and the program executor and the robot control kernel are deployed on the PLC core.

12. A method for simulating motion of a robot in a control system, comprising:
translating a motion command for the robot from a robot operator to a format identifiable by a robot control kernel of the control system;
generating robot motion data based on the motion command translated by the robot control kernel; and
simulating the motion of the robot based on the robot motion data generated and physical conditions of the robot during robot simulation.

13. The method of claim 12, further comprising:
configuring an operation mode for the robot control kernel by the robot control kernel according to an operation mode instruction for the robot, wherein the operation mode includes one of a simulation mode and a real mode; and
communicating the robot motion data generated to a robot Digital Twin of the control system when the operation mode configured is the simulation mode or communicating the robot motion data generated to a drive for a motor on the robot when the operation mode configured is the real mode.

14. The method of claim 13, further comprising:
parsing an operation mode command for the robot to identify the operation mode instruction.

15. The method of claim 13, further comprising:
receiving real robot motion data from the drive when the operation mode configured is the real mode, and
simulating the motion of the robot based on the real robot motion data received.

16. The method of claim 13, further comprising:
adjusting the robot motion data generated based on the motion data simulated when the configured operation mode is the simulation mode.

17. The method of claim 13, further comprising:
receiving real robot motion data from the drive when the operation mode configured is the real mode, and
adjusting the robot motion data generated based on the real robot motion data received.

18. An apparatus for simulating motion of a robot in a control system, comprising:
a translating means for translating a motion command for the robot to a format identifiable by a generating means;
the generating means for generating robot motion data based on the motion command translated; and
a simulating means for simulating the motion of the robot based on the robot motion data generated and physical conditions of the robot during robot simulation.

19. A computer system for simulating motion of a robot in a control system, comprising:
one or more processors; and
a memory coupled to the one or more processors, for storing computer-executable instructions that, when executed, cause the one or more processors to perform the method of claim 12.

20. A non-transitory computer-readable medium storing computer-executable instructions to cause a computer system to perform the method of claim 12 when executed.

21. The control system of claim 3, wherein the robot Digital Twin is further configured to:
receive real robot motion data from the drive when the operation mode is the real mode, and
simulate the motion of the robot based on the real robot motion data received.

22. The method of claim 14, further comprising:
receiving real robot motion data from the drive when the operation mode configured is the real mode, and
simulating the motion of the robot based on the real robot motion data received.
